(19) United States
(12) Patent Application Publication
(10) Pub. No.: US 2024/0153278 A1
(43) Pub. Date: May 9, 2024

(54) APPARATUS FOR PREDICTING A DRIVING PATH OF A VEHICLE AND A METHOD THEREFOR

(71) Applicants: HYUNDAI MOTOR COMPANY, Seoul (KR); KIA CORPORATION, Seoul (KR)

(72) Inventors: Seulgi Kim, Suwon-si (KR); Yimju Kang, Seoul (KR)

(73) Assignees: HYUNDAI MOTOR COMPANY, Seoul (KR); KIA CORPORATION, Seoul (KR)

(21) Appl. No.: 18/142,677

(22) Filed: May 3, 2023

(30) Foreign Application Priority Data
Nov. 3, 2022 (KR) 10-2022-0145334

(51) Int. Cl. G06V 20/58; G06V 20/56

(52) U.S. Cl. CPC G06V 20/58; G06V 20/588

(57) ABSTRACT

An apparatus for predicting a driving path of a vehicle and a method therefor are provided. The apparatus includes a camera that captures an image around an ego vehicle, a light detection and ranging (LiDAR) sensor that generates a point cloud around the ego vehicle, and a controller that detects pieces of feature information of respective vehicles located around the ego vehicle based on the image and the point cloud and predicts a driving path of a target vehicle based on the pieces of feature information of the respective vehicles.

### CROSS-REFERENCE TO RELATED APPLICATION

This application claims the benefit of and priority to Korean Patent Application No. 10-2022-0145334, filed in the Korean Intellectual Property Office on Nov. 3, 2022, the entire contents of which are incorporated herein by reference.

### TECHNICAL FIELD

The present disclosure relates to technologies of predicting a driving path of a target vehicle with regard to a behavior of a surrounding vehicle.

### BACKGROUND

In the field of artificial intelligence, an artificial neural network (ANN) is an algorithm that allows a machine to be trained by simulating and learning a human neural structure. Recently, the ANNs have been applied to image recognition, speed recognition, natural language processing, and the like, and have shown excellent results. The ANN is composed of an input layer for receiving an input, a hidden layer for performing learning, and an output layer for returning the result of the operation. A deep neural network (DNN) with a plurality of hidden layers is a type of the ANN.

The ANN allows a computer to learn on its own from data. When solving a certain problem using the ANN, an appropriate ANN model and data to be analyzed need to be prepared. An ANN model for solving a problem is learned based on data. Prior to training the model, there is desired to divide the data into two types. In other words, the data should be divided into a training dataset and a validation dataset. The training dataset is used to train the model, and the validation dataset is used to validate performance of the model.

There are several reasons for validating an ANN model. An ANN developer corrects a hyper parameter of the model based on the result of validating the model to tune the model. Furthermore, the model is validated to select which model is suitable among several models. The reasons why model validation is necessary are described in more detail as follows.

The first reason is to predict accuracy of the model. The purpose of the ANN is to achieve good performance on out-of-sample data which is not used for training. Therefore, after creating the model, it is essential to verify how well the model will perform on out-of-sample data. However, because the model should not be validated using the train dataset, accuracy of the model should be measured using the validation dataset independent of the train dataset.

The second reason is to enhance performance of the model by tuning it. For example, overfitting may be prevented. The overfitting refers to when the model is overtrained on the training dataset. As an example, when training accuracy is high and when validation accuracy is low, the possibility of overfitting may be suspected. This may be identified in detail by means of a training loss and a validation loss. When the overfitting occurs, it should be prevented to enhance accuracy of validation. The overfitting may be prevented using a method such as regularization and dropout.

Meanwhile, because an existing technology, which predicts a path of a vehicle which travels on the road, simply predicts a driving path of a target vehicle based on shape information of the road and driving information of the target vehicle, without regard to correlations among respective vehicles which travel on the road, the prediction of the target vehicle's driving path is not highly accurate.

The statements in this BACKGROUND section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides an apparatus for predicting a driving path of a vehicle to detect pieces of feature information of respective vehicles which travel on the road based on a camera image and LiDAR data and predict a driving path of a target vehicle based on the pieces of feature information of the respective vehicles to predict the driving path of the target vehicle to have high accuracy and a method therefor.

The apparatus for predicting the driving path of the vehicle may use a deep learning model (e.g., a convolutional neural network) to perform semantic segmentation of the camera image and use a transformer network as a prediction model for predicting the driving path of the target vehicle based on the pieces of feature information of the respective vehicles, in the process of detecting the pieces of feature information of the respective vehicles which travel on the road based on the camera image and the LiDAR data.

The apparatus for predicting the driving path of the vehicle may train a deep learning model to perform the semantic segmentation of the camera image and train the transformer network to predict the driving path of the target vehicle based on the pieces of feature information of the respective vehicles.

The purposes of the present disclosure are not limited to the aforementioned purposes, and any other purposes and advantages not mentioned herein should be clearly understood from the following description and may more clearly known by an embodiment of the present disclosure. Furthermore, it may be easily seen that purposes and advantages of the present disclosure may be implemented by means indicated in claims and a combination thereof.

According to an aspect of the present disclosure, an apparatus for predicting a driving path of a vehicle may include: a camera that captures an image around an ego vehicle, a light detection and ranging (LiDAR) sensor that generates a point cloud around the ego vehicle, and a controller that detects pieces of feature information of respective vehicles located around the ego vehicle based on the image and the point cloud. The controller predicts a driving path of a target vehicle based on the pieces of feature information of the respective vehicles.

In an embodiment of the present disclosure, the pieces of feature information of the respective vehicles may include at least one of positions, speeds, heading angles, heading angle change rates, or driving lanes of the respective vehicles, or any combination thereof.

In an embodiment of the present disclosure, the controller may perform semantic segmentation of the image.

In an embodiment of the present disclosure, the controller may match the image, the semantic segmentation of which is performed, with the point cloud and may detect a vehicle and a traffic line from the captured image.

In an embodiment of the present disclosure, the controller may track the detected vehicle and the detected traffic line based on a motion and measurement model (MAMM).

In an embodiment of the present disclosure, the apparatus may further include storage storing the trained transformer network.

In an embodiment of the present disclosure, the controller may predict the driving path of the target vehicle based on the transformer network.

In an embodiment of the present disclosure, the transformer network may predict positions of the respective vehicles at a future time point, based on input vectors of the respective vehicles at a past time point and input vectors of the respective vehicles at a current time point.

In an embodiment of the present disclosure, the transformer network may encode pieces of space information of the respective vehicles with respect to driving lanes of the respective vehicles, or any combination thereof.

According to another aspect of the present disclosure, a method for predicting a driving path of a vehicle may include: capturing, by a camera sensor, an image around an ego vehicle; generating, by a LiDAR sensor, a point cloud around the ego vehicle; and detecting, by a controller, pieces of feature information of respective vehicles located around the ego vehicle based on the image and the point cloud. The method further includes predicting, by the controller, driving path of a target vehicle based on the pieces of feature information of the respective vehicles.

In an embodiment of the present disclosure, detecting the pieces of feature information of the respective vehicles may include performing semantic segmentation of the image.

In an embodiment of the present disclosure, detecting the pieces of feature information of the respective vehicles may include: matching the image, on which the semantic segmentation is performed, with the point cloud and detecting a vehicle and a traffic line from the image.

In an embodiment of the present disclosure, detecting the pieces of feature information of the respective vehicles may further include tracking the detected vehicle and the detected traffic line based on a motion and measurement model (MAMM).

In an embodiment of the present disclosure, the method may further include storing, by a storage, a transformer network, training of which is completed.

In an embodiment of the present disclosure, predicting the driving path of the target vehicle may include predicting the driving path of the target vehicle based on the transformer network.

In an embodiment of the present disclosure, predicting the driving path of the target vehicle may further include predicting, by the transformer network, positions of the respective vehicles at a future time point, based on input vectors of the respective vehicles at a past time point and input vectors of the respective vehicles at a current time point.

In an embodiment of the present disclosure, predicting the driving path of the target vehicle may further include: encoding, by the transformer network, pieces of space information of the respective vehicles with respect to driving lanes of the respective vehicles.

### BRIEF DESCRIPTION OF THE DRAWINGS

The above and other objects, features and advantages of the present disclosure should be more apparent from the following detailed description taken in conjunction with the accompanying drawings:

FIG. 1 is a block diagram illustrating a configuration of an apparatus for predicting a driving path of a vehicle according to an embodiment of the present disclosure;

FIG. 2 is a diagram illustrating a process of detecting pieces of feature information of respective vehicles which travel on the road in a controller provided in an apparatus for predicting a driving path of a vehicle according to an embodiment of the present disclosure;

FIG. 3A is a view illustrating a road image captured by a camera sensor provided in an apparatus for prediction a driving path of a vehicle according to an embodiment of the present disclosure;

FIG. 3B is a view depicting a road image on which semantic segmentation is performed by a deep learning model provided in an apparatus for prediction a driving path of a vehicle according to an embodiment of the present disclosure;

FIG. 3C is a view illustrating a point cloud measured by a LiDAR sensor provided in an apparatus for predicting a driving path of a vehicle according to an embodiment of the present disclosure;

FIG. 3D is a view illustrating a vehicle and a traffic line detected by matching a road image, on which semantic segmentation performed, with a point cloud in a controller provided in an apparatus for predicting a driving path of a vehicle according to an embodiment of the present disclosure;

FIG. 4 is a view illustrating the result of encoding pieces of space information of respective vehicles based on driving lanes of the respective vehicles in a transformer network provided in an apparatus for predicting a driving path of a vehicle according to an embodiment of the present disclosure;

FIG. 5 illustrates a process of considering an inter-vehicle correlation in a transformer network provided in an apparatus for predicting a driving path of a vehicle according to an embodiment of the present disclosure;

FIG. 6 is a view illustrating an example of performance of an apparatus for predicting a driving path of a vehicle according to an embodiment of the present disclosure;

FIG. 7 is a view illustrating another example of performance of an apparatus for predicting a driving path of a vehicle according to an embodiment of the present disclosure;

FIG. 8 is a flowchart illustrating a method for predicting a driving path of a vehicle according to an embodiment of the present disclosure; and

FIG. 9 is a block diagram illustrating a computing system for executing a method for predicting a driving path of a vehicle according to an embodiment of the present disclosure.

### DETAILED DESCRIPTION

Hereinafter, some embodiments of the present disclosure are described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions has been omitted in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

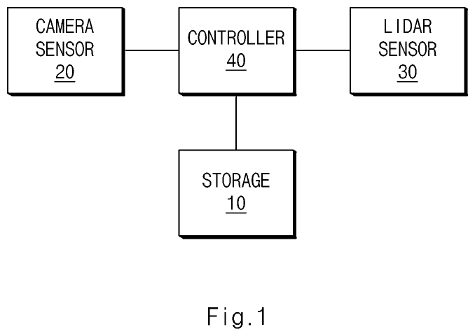

FIG. 1 is a block diagram illustrating a configuration of an apparatus for predicting a driving path of a vehicle according to an embodiment of the present disclosure.

As shown in FIG. 1, the apparatus for predicting the driving path of the vehicle according to an embodiment of the present disclosure may include storage 10, a camera sensor 20, a light detection and ranging (LiDAR) sensor 30, and a controller 40. In one embodiment, the respective components may be combined into one component and some components may be omitted, depending on a manner which executes the apparatus for predicting the driving path of the vehicle according to an embodiment of the present disclosure.

The storage 10 may store various logic, algorithms, and programs that may cause a processor to perform a process of detecting pieces of feature information of respective vehicles which travel on the road based on a road image captured by the camera sensor 20 and a point cloud measured by the LiDAR sensor 30 and predicting a driving path of a target vehicle based on the pieces of feature information of the respective vehicles. Furthermore, the feature information of the vehicle may include at least one of a position (x, y) of the vehicle, a speed of the vehicle, a heading angle of the vehicle, a heading angle change rate of the vehicle, or a driving lane of the vehicle. The heading angle change rate refers to a heading angular velocity of the vehicle. Furthermore, the target vehicle refers to at least one of the respective vehicles which travel on the road. In addition, such feature information of the vehicle may be extracted in a process of tracking the vehicle based on a Kalman filter.

The storage 10 may store a deep learning model (e.g., a CNN, the training of which is completed) for performing semantic segmentation of a camera image and a transformer network, the training of which is completed, as a prediction model for predicting a driving path of the target vehicle based on the pieces of feature information of the respective vehicles, in the process of detecting the pieces of feature information of the respective vehicles which travels on the road based on the road image captured by the camera sensor 20 and the point cloud measured by the LiDAR sensor 30. Herein, the semantic segmentation refers to classifying an object on a pixel-by-pixel basis in the image.

Such a storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, or an optical disk.

The camera sensor 20 may be in form of a module for capturing images in all directions of the vehicle (e.g., a front direction of the vehicle, a rear direction of the vehicle, a left side direction of the vehicle, and a right side direction of the vehicle), which may include a front view camera, a rear view camera, a left view camera, and a right view camera.

The LiDAR sensor 30 may be in form of a module for generating a point cloud for an object located on the road. The LiDAR sensor 30 may generate, for example, a point cloud for a vehicle and a traffic line located on the road.

The controller 40 may perform the overall control such that respective components may normally perform their own functions. Such a controller 40 may be implemented in the form of hardware, may be implemented in the form of software, or may be implemented in the form of a combination thereof. In one embodiment, the controller 40 may be implemented as, but not limited to, a microprocessor.

Particularly, the controller 40 may perform a variety of control in a process of detecting pieces of feature information of respective vehicles which travel on the road based on the road image captured by the camera sensor 20 and the point cloud measured by the LiDAR sensor 30 and predicting a driving path of a target vehicle based on the pieces of feature information of the respective vehicles. Herein, the respective vehicles which travel on the road refer to vehicles in the road image captured by the camera sensor 20.

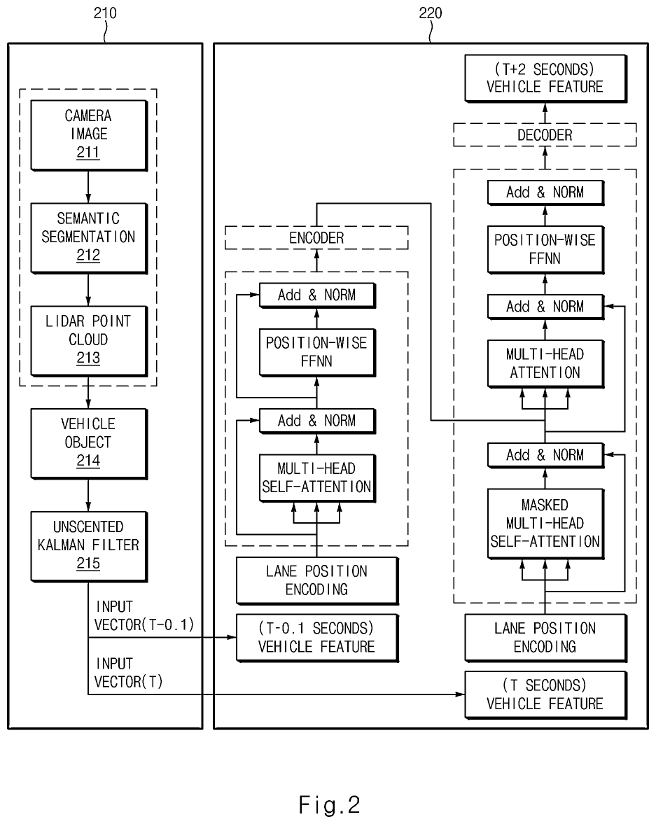

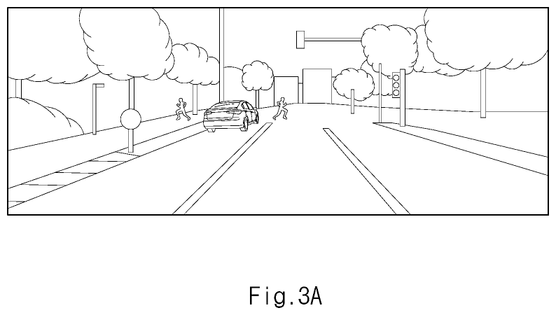

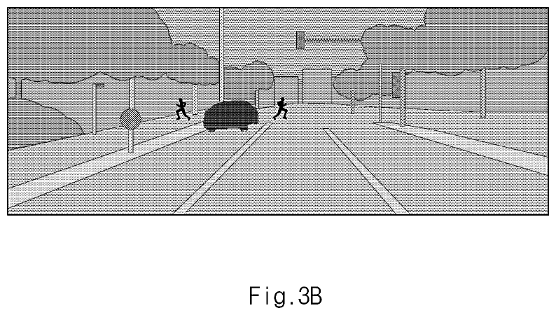

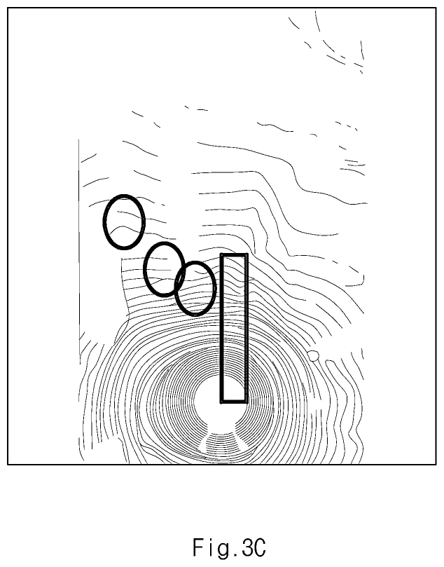

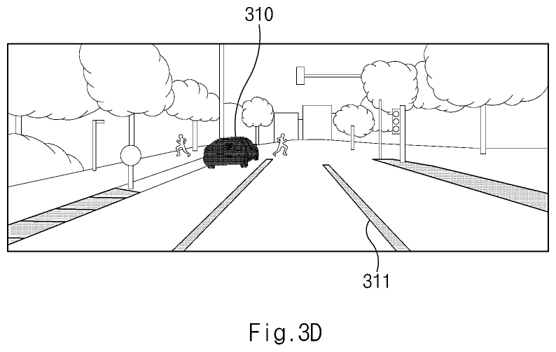

With reference to FIGS. 2-3D, a process 210 of detecting, by the controller 40, pieces of feature information of respective vehicles that travel on the road is described below in detail.

FIG. 2 is a drawing illustrating a process of detecting pieces of feature information of respective vehicles which travel on the road in a controller provided in an apparatus for predicting a driving path of a vehicle according to an embodiment of the present disclosure. FIG. 3A is a drawing illustrating a road image captured by a camera sensor provided in an apparatus for prediction a driving path of a vehicle according to an embodiment of the present disclosure. FIG. 3B is a drawing illustrating a road image, semantic segmentation of which is performed by a deep learning model provided in an apparatus for prediction a driving path of a vehicle according to an embodiment of the present disclosure. FIG. 3C is a drawing illustrating a point cloud measured by a LiDAR sensor provided in an apparatus for predicting a driving path of a vehicle according to an embodiment of the present disclosure. FIG. 3D is a drawing illustrating a vehicle and a traffic line detected by matching a road image, semantic segmentation of which is performed, with a point cloud in a controller provided in an apparatus for predicting a driving path of a vehicle according to an embodiment of the present disclosure.

First of all, in operation 211, a controller 40 of FIG. 1 may receive a road image from a camera sensor 20 of FIG. 1. As an example, the road image is shown in FIG. 3A.

In operation 212, the controller 40 may perform semantic segmentation of the road image based on a deep learning model. As an example, the road image, the semantic segmentation of which is performed, is shown in FIG. 3B.

In operation 213, the controller 40 may receive a point cloud corresponding to the road image from a LiDAR sensor 30 of FIG. 1. As an example, the point cloud is shown in FIG. 3C.

In operation 214, the controller 40 may match the road image, on which the semantic segmentation is performed as shown in FIG. 3B, with the point cloud as shown in FIG. 3C and detect a vehicle and a traffic line. The detected vehicle and the detected traffic line are shown in FIG. 3D.

In operation 215, the controller 40 may tract the vehicle and the traffic line as shown in FIG. 3D. In one form, the controller 40 may track a vehicle 310 and a traffic line 311 using a motion and measurement model (MRMM) or an unscented Kalman filter-based constant turn rate and velocity (CTRV) model, which is generally well known.

Thereafter, the controller 40 may extract pieces of feature information for respective vehicles as an input vector for the transformer network. Furthermore, the feature information of the vehicle may include a position (x, y) of the vehicle, a speed of the vehicle, a heading angle of the vehicle, a heading angle change rate of the vehicle, and a driving lane of the vehicle. The heading angle change rate refers to a heading angular velocity of the vehicle.

As a result, the controller 40 may generate an input vector such as Equation 1 below.

Input vector([x,y,v,θ,\dot{θ},lane]) [Equation 1]

Herein, x denotes the x-axis of the vehicle, y denotes the y-axis of the vehicle, v denotes the speed of the vehicle, θ denotes the heading angle of the vehicle, \dot{θ} denotes the heading angle change rate of the vehicle over time, and lane denotes the driving lane of the vehicle.

Meanwhile, the controller 40 may predict a driving path of a target vehicle based on the transformer network 220, the training of which is completed.

Herein, the transformer network 220, the training of which is completed, may predict positions (x, y), speeds, heading angle change rates, driving lanes, or the like of the respective vehicles at a future time point (T+2 seconds) based on input vectors of the respective vehicles at a past time point (T−0.1 seconds) and input vectors of the respective vehicles at a current time point T. The positions of the vehicle are connected to each other and a driving path of the vehicle is generated.

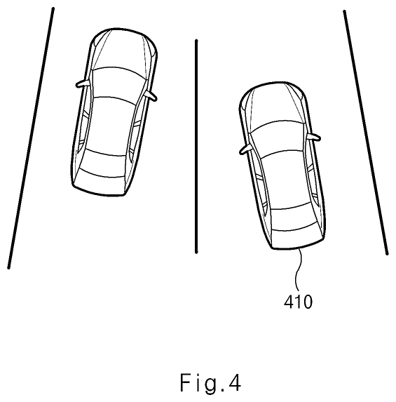

Furthermore, the transformer network 220, i.e., the training of which is completed, may encode pieces of space information of the respective vehicles with respect to driving lanes of the respective vehicles using input vectors of the respective vehicles at the past time point (T−0.1 seconds) (lane position encoding) and may encode pieces of space information of the respective vehicles with respect to the driving lanes of the respective vehicles using the input vectors of the respective vehicles at the current time point T. Herein, the pieces of space information with respect to the driving lanes of the respective vehicles are shown in FIG. 4.

FIG. 4 is a drawing illustrating the result of encoding pieces of space information of respective vehicles based on driving lanes of the respective vehicles in a transformer network provided in an apparatus for predicting a driving path of a vehicle according to an embodiment of the present disclosure.

As shown in FIG. 4, a transformer network 220 of FIG. 2 may identify positions of respective vehicles together with respective driving lanes to intuitively identify the positions of the respective vehicles. For example, vehicle A 410 is located at point (−1, 4) on a second lane.

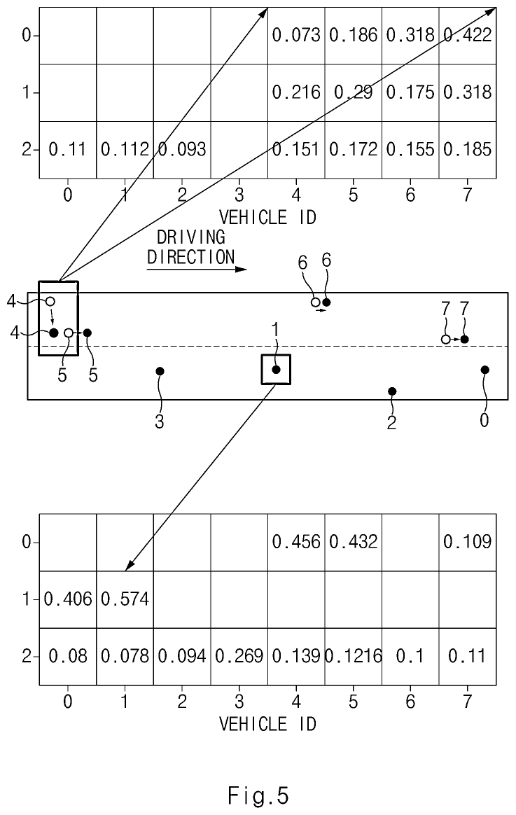

Furthermore, the transformer network 220 may perform “Multi-head Attention” to predict driving paths of all vehicles with regard to correlations among all the vehicles on the road. For example, the process where the transformer network 200 considers the correlations among the vehicles is shown in FIG. 5.

FIG. 5 is a drawing illustrating a process of considering an inter-vehicle correlation in a transformer network provided in an apparatus for predicting a driving path of a vehicle according to an embodiment of the present disclosure.

In FIG. 5, numbers 1 to 7 indicate vehicles, respectively. Particularly, No. 4 vehicle travels (makes a lane change) from its current driving lane to a lane where No. 5 vehicle is located, and No. 1 vehicle maintains its current driving lane.

As shown in FIG. 5, in conjunction with No. 4 vehicle which makes a lane change, it may be seen that a multi-header (No. 0 header, No. 1 header, and No. 2 header) provided in the transformer network 220 pays attention to all of No. 6 vehicle located on the lane where No. 4 vehicle is traveling and No. 5 vehicle and No. 7 vehicle located on the lane to which No. 4 vehicle wants to make a lane change.

However, in conjunction with No. 1 vehicle which maintains the current driving lane, it may be seen that No. 1 header in the multi-header provided in the transformer network 220 pays intensive attention to No. 0 vehicle and No. 1 vehicle. At this time, it may be seen that No. 0 header does not pay attention to No. 1 vehicle and No. 2 header pays low attention to all vehicles in conjunction with No. 1 vehicle. As a result, a vehicle to which No. 0 header pays the utmost attention is No. 4 vehicle (0.456), a vehicle to which No. 1 header pays the utmost attention is No. 1 vehicle (0.574), and a vehicle to which No. 2 header pays the utmost attention is No. 3 vehicle (0.269). A vehicle to which it pays the utmost attention is No. 1 vehicle.

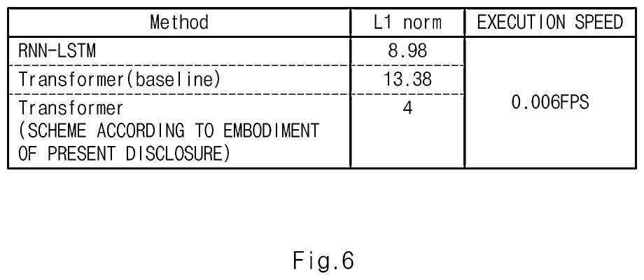

FIG. 6 is a drawing illustrating an example of performance of an apparatus for predicting a driving path of a vehicle according to an embodiment of the present disclosure.

In FIG. 6, “L1 norm” denotes the error calculation metric, the execution speed is 0.006 frame per second (FPS).

As shown in FIG. 6, it may be seen that the error in the RNN-LSTM-based driving path prediction technology is 8.98, the error in the existing technology (baseline) based on the transformer network is 13.38, and the error in the technology according to an embodiment of the present disclosure is 4.

As a result, the error in the technology according to an embodiment of the present disclosure based on the transformer network decreases by 70% compared to the error in the existing technology (baseline) and decreases by 55.4% compared to the error in the RNN-LSTM-based driving path prediction technology.

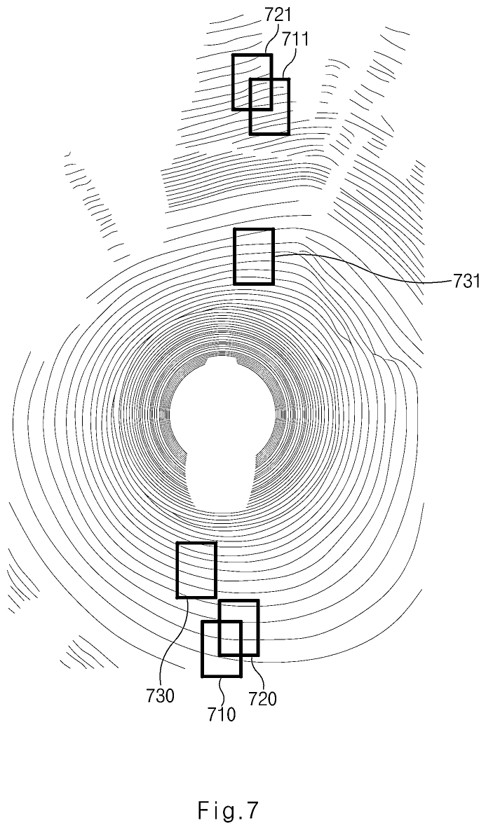

FIG. 7 is a drawing illustrating another example of performance of an apparatus for predicting a driving path of a vehicle according to an embodiment of the present disclosure.

In FIG. 7, reference numeral 710 denotes the actual position of the vehicle at the first time point, reference numeral 720 denotes the position of the vehicle at the first time, which is predicted in the scheme according to an embodiment of the present disclosure, and reference numeral 730 denotes the position of the vehicle at the first time point, which is predicted in the existing scheme (based on RNN-LSTM).

As shown in FIG. 7, the position 720 of the vehicle at the first time point, which is predicted in the scheme according to an embodiment of the present disclosure, is almost identical to the actual position 710 of the vehicle at the first time point, whereas the position 730 of the vehicle at the first time point, which is predicted in the existing scheme, greatly deviates from the actual position 710 of the vehicle at the first time point.

In FIG. 7, reference numeral 711 denotes the actual position of the vehicle at the second time point, reference numeral 721 denotes the position of the vehicle at the second time point, which is predicted in the scheme according to an embodiment of the present disclosure, and reference numeral 731 denotes the position of the vehicle at the second time point, which is predicted in the existing scheme (based on RNN-LSTM).

As shown in FIG. 7, the position 721 of the vehicle at the second time point, which is predicted in the scheme according to an embodiment of the present disclosure, is almost identical to the actual position 711 of the vehicle at the second time point, whereas the position 731 of the vehicle at the second time point, which is predicted in the existing scheme, greatly deviates from the actual position 711 of the vehicle at the second time point.

Meanwhile, a controller 40 of FIG. 1 may deliver pieces of predicted driving information of the respective vehicles to an advanced driver assistance system (ADAS), such that the ADAS may be used to determine a situation around an ego vehicle and control a behavior of the ego vehicle.

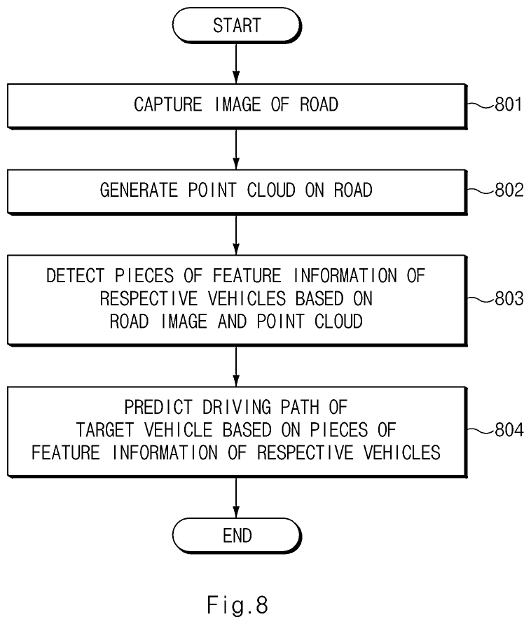

FIG. 8 is a flowchart illustrating a method for predicting a driving path of a vehicle according to an embodiment of the present disclosure. A road image in an image around an ego vehicle is described as an example.

First of all, in operation 801, a camera sensor 20 of FIG. 1 may capture an image of a road.

In operation 802, a LiDAR sensor 30 of FIG. 1 may generate a point cloud on the road.

In operation 803, a controller 40 of FIG. 1 may detect pieces of feature information of respective vehicles on the road based on the road image and the point cloud.

In operation 804, the controller 40 may predict a driving path of a target vehicle based on the pieces of feature information of the respective vehicles. Herein, the target vehicle refers to at least one of the respective vehicles.

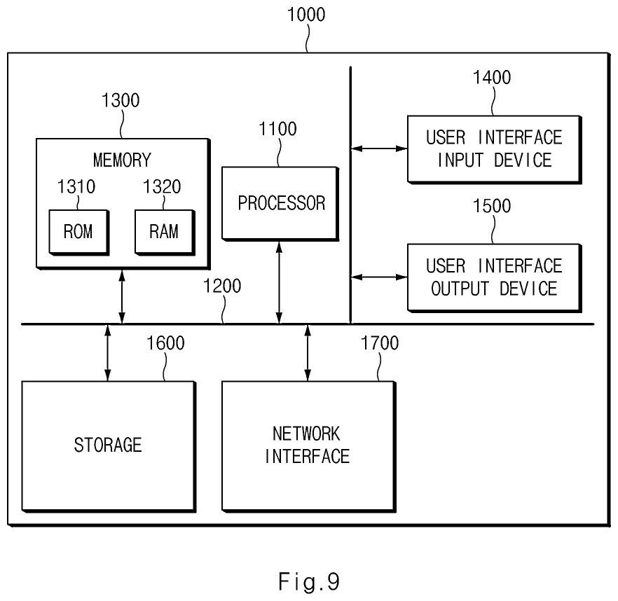

FIG. 9 is a block diagram illustrating a computing system for executing a method for predicting a driving path of a vehicle according to an embodiment of the present disclosure.

Referring to FIG. 9, the above-mentioned method for predicting the driving path of the vehicle according to an embodiment of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a SSD (Solid State Drive), a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for predicting the driving path of the vehicle and the method therefor may be provided to detect pieces of feature information of respective vehicles which travel on the road based on a camera image and LiDAR data and predict a driving path of a target vehicle based on the pieces of feature information of the respective vehicles, thus predicting the driving path of the target vehicle to have high accuracy.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure.

Therefore, the embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for predicting a driving path of a vehicle, the apparatus comprising:
a camera configured to capture an image around an ego vehicle;
a light detection and ranging (LiDAR) sensor configured to generate a point cloud around the ego vehicle; and
a controller configured to detect pieces of feature information of respective vehicles located around the ego vehicle based on the image and the point cloud and configured to predict a driving path of a target vehicle based on the pieces of feature information of the respective vehicles.

2. The apparatus of claim 1, wherein the pieces of feature information of the respective vehicles include at least one of positions, speeds, heading angles, heading angle change rates, or driving lanes of the respective vehicles, or any combination thereof.

3. The apparatus of claim 1, wherein the controller is configured to perform semantic segmentation of the image.

4. The apparatus of claim 3, wherein the controller is configured to match the image, on which the semantic segmentation is performed, with the point cloud and configured to detect a vehicle and a traffic line from the captured image.

5. The apparatus of claim 4, wherein the controller is configured to track the detected vehicle and the detected traffic line based on a motion and measurement model (MAMM).

6. The apparatus of claim 1, further comprising:
a storage configured to store a transformer network, training of which is completed.

7. The apparatus of claim 6, wherein the controller is configured to predict the driving path of the target vehicle based on the transformer network.

8. The apparatus of claim 7, wherein the transformer network is configured to predict positions of the respective vehicles at a future time point based on input vectors of the respective vehicles at a past time point and input vectors of the respective vehicles at a current time point.

9. The apparatus of claim 7, wherein the transformer network is configured to encode pieces of space information of the respective vehicles with respect to driving lanes of the respective vehicles.

10. A method for predicting a driving path of a vehicle, the method comprising:
capturing, by a camera sensor, an image around an ego vehicle;
generating, by a light detection and ranging (LiDAR) sensor, a point cloud around the ego vehicle;
detecting, by a controller, pieces of feature information of respective vehicles located around the ego vehicle based on the image and the point cloud; and
predicting, by the controller, driving path of a target vehicle based on the pieces of feature information of the respective vehicles.

11. The method of claim 10, wherein the pieces of feature information of the respective vehicles include at least one of positions, speeds, heading angles, heading angle change rates, or driving lanes of the respective vehicles, or any combination thereof.

12. The method of claim 10, wherein detecting the pieces of feature information of the respective vehicles includes:
performing, by the controller, semantic segmentation of the image.

13. The method of claim 12, wherein detecting the pieces of feature information of the respective vehicles includes:
matching, by the controller, the image on which the semantic segmentation is performed, with the point cloud and detecting a vehicle and a traffic line from the captured image.

14. The method of claim 13, wherein detecting the pieces of feature information of the respective vehicles further includes:
tracking, by the controller, the detected vehicle and the detected traffic line based on a motion and measurement model (MAMM).

15. The method of claim 10, further comprising:
storing, by a storage, a transformer network, training of which is completed.

16. The method of claim 15, wherein predicting the driving path of the target vehicle includes:
predicting, by the controller, the driving path of the target vehicle based on the transformer network.

17. The method of claim 16, wherein predicting the driving path of the target vehicle further includes:
predicting, by the transformer network, positions of the respective vehicles at a future time point based on input vectors of the respective vehicles at a past time point and input vectors of the respective vehicles at a current time point.

18. The method of claim 16, wherein predicting the driving path of the target vehicle further includes:
encoding, by the transformer network, pieces of space information of the respective vehicles with respect to driving lanes of the respective vehicles.
